(19) United States
(12) Patent Application Publication
(10) Pub. No.: US 2015/0317567 A1
(43) Pub. Date: Nov. 5, 2015

(54) Business Change Management System

(71) Applicant: Yeejang James Lin, San Jose, CA (US)

(72) Inventor: Yeejang James Lin, San Jose, CA (US)

(21) Appl. No.: 14/267,665

(22) Filed: May 1, 2014

(51) Int. Cl. G06Q 10/00; G06F 17/30

(52) U.S. Cl. CPC G06Q 10/00; G06F 17/30404

(57) ABSTRACT

A method for business change management process includes receiving a change request, assigning an identification number to the change request, generating database commands, including the identification number into the database commands, and recording the change request, the database commands, and responses to the database commands. The auditing process of the changes is done by retrieving instances of the change requests and events of the database modification and then matching the events to the instances.

### FIELD OF THE INVENTION

The present invention generally relates to database and more specifically to a method for managing changes to a large database.

### BACKGROUND OF THE INVENTION

FIG. 1 illustrates a process 100 that generally happens in a corporation when a change is needed. When a manager 102 needs to make a change in the business, usually the manager 102 issues a change order, which is generally entered on the manager's work station 104. The change order is then carried out by a subordinate 106 and the change may translate in changes in one or more databases stored in one or more servers 108, 110. In this process 100, manager 102 will have no way of knowing if the change is carried out properly.

The method described above is slow and unreliable because it involves multiple people and also does not allow a prompt verification of a work requested and implemented. Hence, it is imperative to devise a system and method that enables easy implementation of a request and also prompt verification of the implementation result and it is to this system the present invention is primarily directed.

### SUMMARY OF THE INVENTION

The present invention has been made to overcome the aforementioned disadvantages of conventional methods. The primary object of the present invention is to provide a method for auditing business changes.

The present invention provides a method for implementing a business change request. The method comprises receiving, from a user interface unit, a business change request, generating, by an auditing unit, an identifier for the business change request, generate, by a database modification unit, at least one database command for implementing the business change request, inserting, by the database modification unit, the identifier into the at least one database command, and executing, by the database modification unit, the at least one database command.

The present invention also provides a method for auditing business changes. The method comprises retrieving, by an audit policy unit, a audit policy from a storage unit, retrieving, by an auditing unit, a plurality of business change requests from the storage unit according to the audit policy, retrieving, by the auditing unit, a plurality of events associated with database modification, associating, by the auditing unit, each business change request with at least one event, associating, by the auditing unit, each event with at least one business change request, and presenting, by a notification unit, unmatched events and business change requests to a user.

The present invention further provides a system for auditing business change requests. The system comprises an audit policy unit, an auditing unit, and a database modification unit. The audit policy unit retrieves an audit policy from a storage unit and auditing unit generates an identifier for each business change request and retrieves a plurality of business change requests from the storage unit according to the audit policy. The database modification unit generates at least one database command for each business change request and for inserting an identifier into each database command. The auditing unit retrieves a plurality of events associated with at least one database command according to the audit policy, associates each business change request with at least one event, associates each event with at least one business change request, and presents unmatched events and business change requests to a user.

The foregoing and other objects, features, aspects and advantages of the present invention will become better understood from a careful reading of a detailed description provided herein below with appropriate reference to the accompanying drawings. It is noted that the technology is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The present invention can be understood in more detail by reading the subsequent detailed description in conjunction with the examples and references made to the accompanying drawings, wherein:

FIG. 1 shows a prior method 100 for business change request;

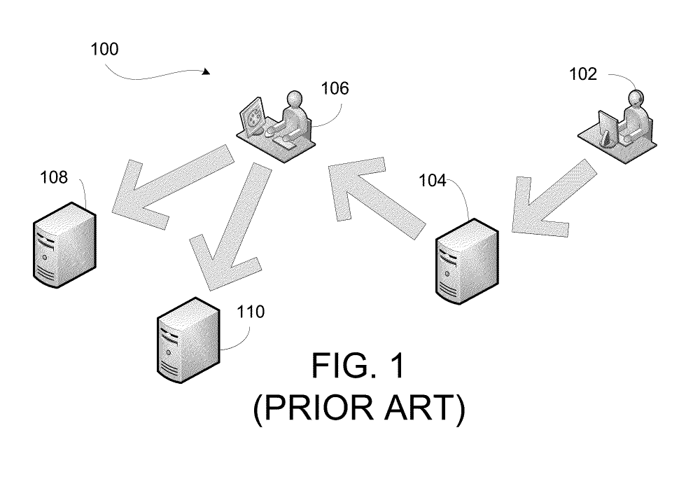

FIG. 2 illustrates a process 200 for auditing changes requests performed in a business system;

FIG. 3 is architecture 300 of a business change management system according to one embodiment of the present invention;

FIG. 4 is a flowchart 400 for a change request implementation;

FIG. 5 is a process 500 for making a business change request;

FIG. 6 is a flowchart 600 for auditing changes to a business system; and

FIG. 7 is an alternative architecture 700 of a business change management system according to one embodiment of the present invention.

### DETAILED DESCRIPTION OF THE PREFERRED EMBODIMENTS

In the following description, events refer to data transaction activities, including queries and responses, and instances refer to human activities, which trigger data transaction activities. One instance of user activity may trigger one or more events. Identification number and identifier are used interchangeably in the following description.

The business change management system of the present invention links “what happened” to a business system with “what was intended” for the business system, thus allowing easy verification of changes made to the business system. The changes include network changes, database changes, system configuration changes, data changes, etc. The business change management system also enables users to roll back the changes made to the business system.

When a change or a modification is desired in a business system, usually a change request is entered. The change request may be entered through a web page or using a proprietary software and the change request is sent to a support staff, usually an information technology (IT) personnel. The change request is then executed by issuing one or more database command, usually a plurality of structure query language (SQL) commands. One change request may result in modification to one or more databases. For example, hiring a new employee to a corporation involves adding a new entry in a payroll database, adding a new entry in a benefit database, adding a new entry in an organizational database, etc. Each modification to a database is recorded as an event and the events are resulted from instances of the user's command.

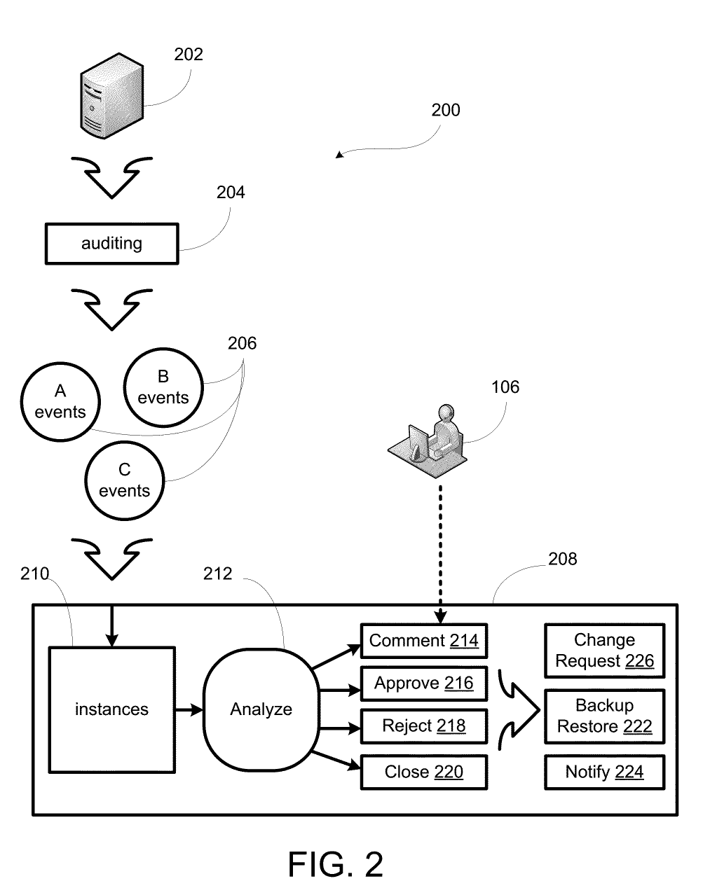

FIG. 2 illustrates a process 200 for auditing changes requests performed by the business change management system of the present invention. Generally, the change requests are implemented and recorded on one or more business databases stored on a server 202. Through an auditing process 204, events 206 that happened during implementation of the change requests are retrieved, filtered and grouped as instances 210. These instances are analyzed 212 and the results are presented to a user 106. The user 106 can then decide what to do next. For example, several employees may have been hired recently and their information entered into the business system and in the server 202. A manager may want to verify that data for these new employees are entered properly and the manager may start an auditing process 204 using the business change management system. The events 206 related to creation of a record for each employee are retrieved and grouped as the instances 210. These instances 210 are analyzed 212. The analysis result is presented to the manager and the manager can approve the changes 216 or reject the changes 218 if the manager notices some problem. The manager can also write a comment 214 or just close the auditing process 204. If the manager decides to approve or reject, which means further modification of the database, a new change request 220 will be generated. The database may be restored 222 if the changes are rejected. The database may be backed up 222 if the changes are approved and made permanent. The business system may provide a notification 324 about the result of the auditing process.

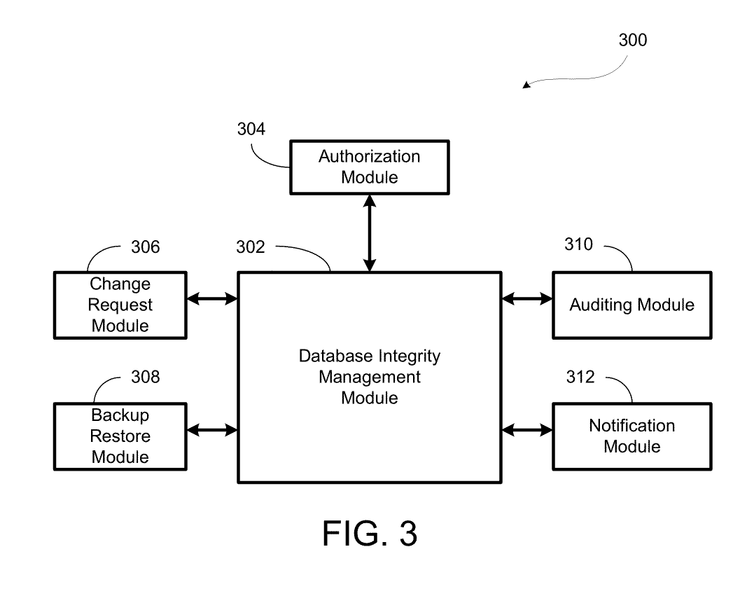

FIG. 3 is architecture 300 of the business change management system according to one embodiment of the present invention. The business change management system comprises a database integrity management module 302, a user authorization/authentication module 304, a change request module 306, a backup restore module 308, an auditing module 310, and a notification module 312. The user authorization/authentication module 304 is responsible for user identity verification by checking user's login ID and user's password or other means of verification. The change request module 306 interfaces with the user by receiving change request commands and interpreting the change request commands. The change request commands area also recorded by the change request module 306. The backup restore module 308 is responsible for backing up and restoring databases. The auditing module 310 performs database auditing functions by correlating database modification events with instances of change request commands. The auditing module 310 generally captures non-authorized events, confirms authorized-and-done events, and assures that only authorized changes and access are performed to the database. The notification module 312 interfaces with users and provides notifications to the users. The database management module 302 is responsible for coordinating the actions from different modules and also controlling access to and modification of the databases.

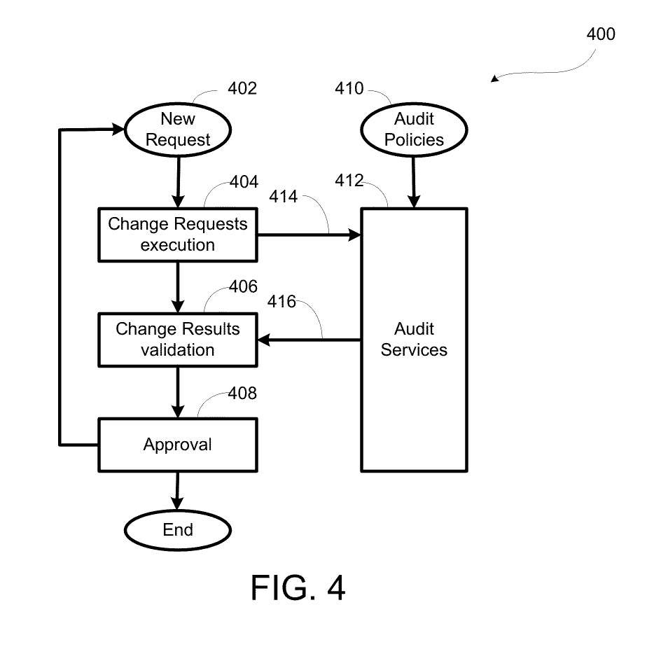

FIG. 4 is a flowchart 400 for a change request implementation. When a new business change request, step 402, is received, the business change request is implemented, step 404, through one or more database modification commands. The change request that is generated is assigned an identifier (identification number) and this identification number will be used and associated with all the events resulting from this change request. These database modification commands and data, which include change request identification numbers and change request content, are also recorded, step 414, for future use by the auditing process, step 412. The database modification commands and the change requests may be stored in the same server or in different servers. A set of auditing policies is also available to the auditing process. After the database is modified to implement the business change requests, the database change results is validated, step 406, and the validation is done by is done by using information, which includes change request identification numbers and change request content, supplied by the auditing process, step 416. If the change results are validated, the business change request is approved, step 408, and if the errors are detected, new change request may be issued to correct the errors.

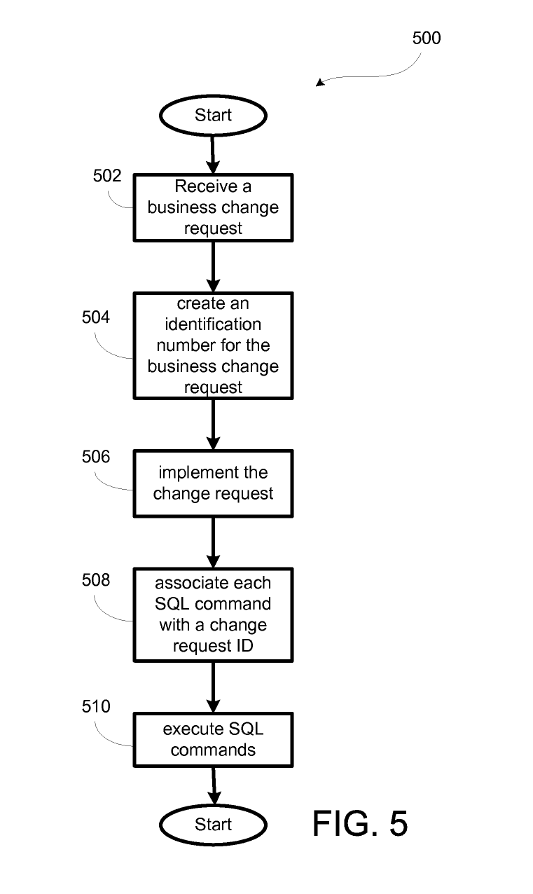

FIG. 5 is a process 500 for making a business change request. When a business change request is received, step 502, the business change management system creates or generates a unique identifier (ID) for the business change request, step 504. For example, adding a newly hired employee, James, is desired and a change request—add new employee James—is issued and assigned a request ID 1234. The identifier is a unique within a specific time period. The change request “add new employee James” is sent to a technical personnel to be implemented, step 506. This change request may generate several SQL commands and change more than one database. For example, adding a new employee will lead to create a new entry in the employee database, create a new entry in an organization database, assign a role to the newly created entry in the organization database, and assign a privilege level to the newly created entry. Every SQL command is associated with the ID assigned to the business change request, step 508, and the SQL commands are then executed, step 510. While the business change request and the SQL commands are executed, the information for the business change request and the SQL commands are monitored and recorded as part of auditing process.

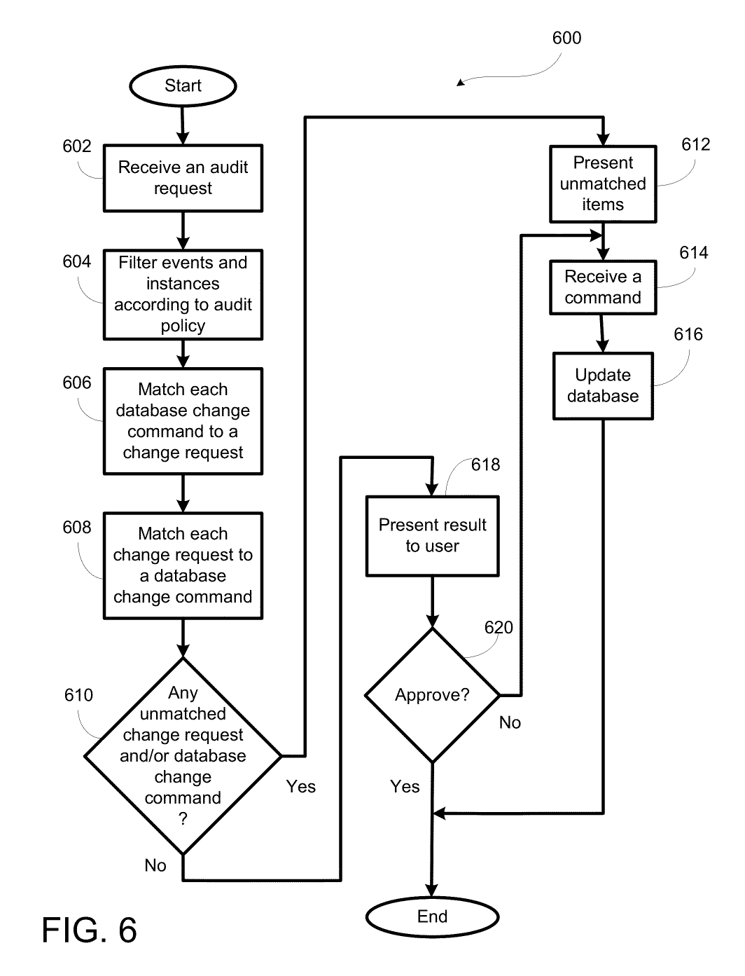

FIG. 6 is a process 600 for auditing changes to a business system. The audit can be started as an independent action started by a user or as part of validation after a change request is executed by the business system. When an audit request is received, step 602, the auditing module 310 of the business change management system retrieves an audit policy from an audit database and filters events and instances from one or more databases, step 604. For example, the audit request can be for all change requests to the business system requested by manager David during last week. The instances of changes requests created by manager David during the last week will be retrieved and all the events associated with the identification numbers assigned to these instances are retrieved from the databases. Every change to the database, represented by events, is matched to a change request, represented by instances, step 606, and every change request is matched to one or more database changes, step 608. It is checked whether there is any unmatched change request or SQL command, step 610. If there are unmatched items, the unmatched items are presented to the user, step 612, and the user can enter additional command, step 614, to correct the mistake and the database can be updated according to the user's additional command, step 616. If there is no unmatched item, the result is presented to the user, step 618, and the user can decide to approval the changes, step 620, or make additional changes and steps 614 and 616 will be executed as part of additional commands from the user. The user may also make annotations on any record in the database.

Unmatched items may happen if there is data corruption or some unauthorized changes. There may be errors even there is no unmatched items. For example, if the change request is to change the compensation of an existing user Mary and it involves change to the salary database, however, the person who executed the change request took the opportunity and used the same change request ID to change the salary of several people instead of changing only the salary for Mary. This unauthorized change is not easily detectable but can be detected by the user auditing the changes.

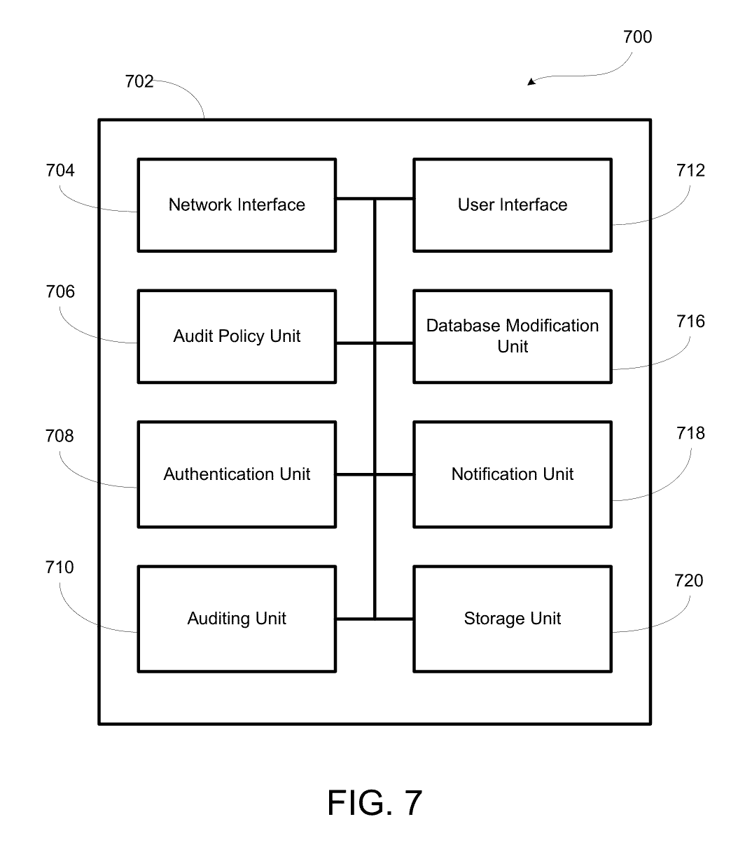

FIG. 7 is an alternative architecture 700 of a business change management system 702 according to the present invention. The business change management system 702 has a network interface unit 704, a user interface unit 712, an audit policy unit 706, a database modification unit 716, an authentication unit 708, a notification unit 718, an auditing unit 710, and a storage unit 720. The network interface unit 704 communicates with other database servers on the network and also communicates other devices used by remote users. The user interface unit 712 controls interface with local users. The audit policy unit 706 is responsible for creating and retrieving audit policies and the auditing unit 710 receives audit requests from users and then retrieves the audit policy through the audit policy unit 706. The authentication unit 708 controls user access by authenticating users. The database modification unit 716 is responsible for controlling the access and modification to the database that can be located locally in the business change management system 702 or remotely. The database modification unit 716 can generate SQL commands for the business change requests and insert the identifier into these SQL commands. The database modification unit 716 can also executes these SQL commands if the database is local to the business management system 702. If the database is not local, then the SQL commands are sent to a server in which the database is stored. The notification unit 718 is responsible for sending notices and communications to the users. The storage unit 720 stores databases, including the audit policies. Different units illustrated in FIG. 7 and described above may be combined and functions described above maybe performed by the combined units.

The business change system shown in FIG. 7 may also be able to interface with a business user and to receive a business change request through the user interface unit 712 and generate by the auditing unit 710 an identifier for the business change request.

In operation, the business change management system of the present invention enables a user to easily audit the changes made to a business system. The business change management system monitors change requests issued by a business user and also monitors the implementation of these change requests by a support staff. When a change request is issued, an identification number is generated and associated with the change request. When the change request is handed to the support staff for entry, the support staff will issue one or more SQL commands and each command will be issued with the same identification number listed on the change request. Examples of a change request and a SQL command are listed below.
Request=Request ID=1234, add a new employee, Mary, to employee table on DBserver1
SQL command=“Insert name, department, phone into employee values (‘mary’, ‘HR’, ‘408-123-4567’)--ID=1234”, Server=Dserver1, DBUser=ITstaff

As it can be seen above, the identification number “1234” is added to the SQL command, usually as part of a comment, and now the request and the SQL command can be associated to each other.

After the change request is implemented, the user who requested the change request can verify the change by requesting an audit. The user can perform the audit by selecting an audit policy from the audit policy store. For example, the user can audit the changes to the employee database done in last seven days. The auditing unit in the business change management system will then retrieve instance of the change requests that impact the employee database according to the audit policy from the storage and also retrieve events associated with all the SQL commands associated with these change requests and the corresponding results. Because each change request is assigned an identification number, which is also included in the SQL commands for carrying out the change request, the auditing process can easily match each change request with one or more SQL commands. The result of the auditing process is presented to the user. The user can easily see unmatched change requests and unmatched SQL commands. The user can also see if a change request is matched to more than necessary SQL commands. For example, if a support staff decided to change the access privileges for James, when the support staff is changing the function for Mary, the support staff may use the identification number from the change request for changing Mary's function to also change the access privileges of James. The change for James would not be detected as an unmatched change but the user who is auditing the changes to the database may be able to detect because the identification number for the change to James' privilege is from the change request for changing Mary's function.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures and different embodiments can be easily combined within the scope of the invention.

The present technology has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present technology can be implemented by software, firmware, hardware, or a combination thereof. After reading this description, it will become apparent to a person skilled in the relevant art how to implement the technology using other computer systems and/or computer architectures. Features described in different embodiments described in the present specification may be combined.

It is to be appreciated that the Detailed Description section, and not the Summary and Abstract sections, is intended to be used to interpret the claims. The Summary and Abstract sections may set forth one or more but not all exemplary embodiments of the present technology as contemplated by the inventor(s), and thus, are not intended to limit the present technology and the appended claims in any way.

What is claimed is:

1. A method, for implementing a business change request, comprising:
receiving, from a user interface unit, a business change request;
generating, by an auditing unit, an identifier for the business change request;
generate, by a database modification unit, at least one database command for implementing the business change request;
inserting, by the database modification unit, the identifier into the at least one database command; and
executing, by the database modification unit, the at least one database command.

2. The method of claim 1, wherein the identifier is inserted as a comment into the at least one database command.

3. The method of claim 1, wherein the identifier is a unique number.

4. The method of claim 1, wherein the at least one database command is a structure query language (SQL) command.

5. The method of claim 1, further comprising recording the business change request along with the identifier associated with the business change request.

6. A method, for auditing business changes, comprising:
retrieving, by an audit policy unit, a audit policy from a storage unit;
retrieving, by an auditing unit, a plurality of business change requests from the storage unit according to the audit policy;
retrieving, by the auditing unit, a plurality of events associated with database modification;
associating, by the auditing unit, each business change request with at least one event;
associating, by the auditing unit, each event with at least one business change request; and
presenting, by a notification unit, unmatched events and business change requests to a user.

7. The method of claim 6, further comprising the step of receiving commands for handling the unmatched events and business change requests.

8. The method of claim 6, wherein associating, by the auditing unit, each business change request with at least one event is done by associating an identifier on each business change request with an identifier on at least one event.

9. The method of claim 8, wherein the identifier is inserted as a comment on each event.

10. The method of claim 6, wherein associating, by the auditing unit, each event with at least one business change request is done by associating an identifier on each event with an identifier on at least one business change request.

11. The method of claim 10, wherein the identifier is inserted as a comment on each event.

12. A system, for auditing business change requests, comprising:
an audit policy unit for retrieving an audit policy from a storage unit;
an auditing unit for generating an identifier for each business change request and for retrieving a plurality of business change requests from the storage unit according to the audit policy; and
a database modification unit for generating at least one database command for each business change request and for inserting an identifier into each database command,
wherein
the auditing unit retrieves a plurality of events associated with at least one database command according to the audit policy,
associates each business change request with at least one event,
associates each event with at least one business change request, and
presents unmatched events and business change requests to a user.

13. The system of claim 12, wherein the database modification unit inserts the identifier as a comment into each database command.

14. The system of claim 12, wherein the auditing unit associates each business change request with at least one event by associating an identifier on each business change request with an identifier on at least one event.

15. The system of claim 12, wherein the auditing unit associates each event with at least one business change request by associating an identifier on each event with an identifier on at least one business change request.
